(19) United States
(12) Patent Application Publication
(10) Pub. No.: US 2002/0100895 A1
(43) Pub. Date: Aug. 1, 2002

(54) Chemical mechanical polishing slurry

(76) Inventors: Huang-Chung Cheng, Hsin-Chu City (TW); Cheng-Jer Yang, Tao-Yuan (TW); Ting-Chang Chang, Hsin-Chu City (TW)

Correspondence Address: Powell, Goldstein, Frazer & Murphy, LLP, Suite 600, 1001 Pennsylvania Avenue, Washington, DC, 20004, US

(21) Appl. No.: 09/770,547

(22) Filed: Jan. 26, 2001

(51) Int. Cl. B44C 1/22; C23F 1/00; C03C 15/00

(52) U.S. Cl. 252/79.1; 216/89

(57) ABSTRACT

A chemical mechanical polishing slurry comprising: a nitric acid solution; a weak acid solution, wherein mollar concentration of for weak acid acqeous solution is less than mollar concentration of for nitric acid acqeous solution; and an abrasive. Also, a method for polishing a substrate including at least one metal layer, comprising: mixing a nitric acid solution, a weak acid solution, an abrasive and a solvent to form a chemical mechanical polishing slurry; applying for chemical mechanical polishing slurry to for substrate; and bringing a pad into contact with for substrate and moving for pad in relation to for substrate to remove a portion of for metal layer.

### BACKGROUND OF THE INVENTION

1. Field of the Invention

The invention concerns a chemical mechanical polishing slurry including nitric acid solution, weak acid solution and abrasive. More particularly, this invention concerns a chemical mechanical polishing slurry that is especially adapted for polishing multiple metal layers and thin-films where one of the layers or films is comprises of copper or a copper containing alloy.

2. Description of the Prior Art

Because resistance of copper lines is less than that of aluminum lines and also because electromigration resistance of copper lines also is better than that of aluminum lines, aluminum lines is gradually replaced by copper lines for improving quality of contemporary integrated circuits. Especially when chemical mechanical polishing (CMP) method is developed, application of copper is not limited by the leakage of proper dry etch process for copper.

However, owing to chemical mechanical polishing method just has been applied in semiconductor fabrication for only several years, performance of CMP is not prefect and details of CMP still is a developing field. For instance, slurry is one important factor of CMP, especial copper CMP, but available slurries, especial merchantilize slurries, always meet some unavoidable disadvantages. Herein, often-seen disadvantages at least include etching rate of metal, such as copper, is high and is not well controllable, these disadvantages also at least include high etching rate of barrier layer and an unavoidable result is that adjacent dielectric layer also is thinned or even is removed.

Accordingly, it is desired to develop a new slurry that effectively improves previous disadvantages of available slurries, especially to develop a new slurry that can let etching rate is precisely controllable.

### SUMMARY OF THE INVENTION

The present invention is directed to a chemical mechanical polishing slurry that is able to polish metal, especially copper, containing substrate at controllable etching rates.

In addition, the invention also is directed to a chemical mechanical polishing slurry has a low barrier layer etching rate while having a high etching rate towards copper layer and/or metal layers.

Furthermore, this invention is directed to methods for forming and using a chemical mechanical polishing slurry of copper in fabrication of an integrated circuits.

One embodiment of the invention is a chemical mechanical polishing slurry, comprising a nitric acid solution; a weak acid solution; and an abrasive. Whereby, mollar concentration of the weak acid acqeous solution usually is less than mollar concentration of the nitric acid acqeous solution, and abrasive usually is made with numerous micro-particles.

Other embodiments of the invention are a method for forming a chemical mechanical polishing slurry and a method for polishing a substrate including at least one metal layer. Previous method comprises following steps: provide a nitric acid solution; provide a weak acid solution, wherein mollar concentration of the weak acid solution is less than mollar concentration of the nitric solution; provide an abrasive; and mix the nitric acid solution, the weak acid solution and the abrasive. Another method comprises following steps: mix a nitric acid solution, a weak acid solution, an abrasive and a solvent to form a chemical mechanical polishing slurry; apply the chemical mechanical polishing slurry to the substrate; and bring a pad into contact with the substrate and move the pad in relation to the substrate to remove a portion of the metal layer.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 shows an example of the invention: relation between etching rate and mollar concentration of citric acid;

FIG. 2 shows a brief flow chart of a method for forming the present slurry; and

FIG. 3 shows a brief flow chart of a method for polishing a substrate including at least one metal layer.

### DESCRIPTION OF THE PREFERRED EMBODIMENT

First of all, the Applicants present a new chemical mechanical polishing slurry that essentially at least includes following compositions: nitric acid solution, weak acid solution and abrasive. Herein, function of etching essentially is provided by both the nitric acid solution (chemical reaction) and abrasive (mechanical reaction), and weak acid solution is used to adjust etching rate of the present slurry. In other words, the slurry still can be used to etch metal, such as copper, even weak acid solution is expelled, but ability for precisely controlling etching rate will be lost in that case. Thus, an obvious characteristic of the invention is application of weak acid solution.

Moreover, mollar concentration of the weak acid solution usually is less than mollar concentration of the nitric acid solution, abrasive usually is formed by numerous micro-particles, and these solutions usually are acqeous solution. Besides, volume percent of the nitric acid usually is less than 10.0% and a preferred range is about from 2.0% to 5.0% , mollar concentration of the weak acid solution is from about 0.0005 M to about 0.5 M, and weight percent of the abrasive is less about 10.0%

Further, the weak acid usually is selected from the group consisting of citric acid, phosphoric acid, acetic acid, lactic acid, tartaric acid, succinic acid, oxalic acid and amino acid. However, other weak acid also is available for the claimed invention. Owing to different properties of different weak acid, mollar concentration of the citric acid is from about 0.0005 M to about 0.5 M, mollar concentration of the acetic acid is about from 0.001 M to about 0.5 M, mollar concentration of the phosphoric acid is about from 0.001 M to about 0.1 M.

Herein, mollar concentration of each kind weak acid can be adjusted to let etching rate can be precisely controlled. Similarly, both volume percent of nitric acid and weight percent of abrasive also can be adjusted to precisely adjust etching rate.

Besides, the abrasive usually is formed by numerous alumina particles that weight percent of alumina particles is from about 2% to about 5% However, abrasive is not key point of the claimed invention and any conventional abrasive can used in the present invention,

In addition, pH value of the present slurry usually is less than about 1.0, which is essentially decided by concentration of the nitric acid, and it is not necessary to modify the pH value during operation period of CMP. However, in order to modify pH value for properly adjust etching rate of different cases (different substrate, different thickness of metal layer etc.), pH value of the slurry can be adjusted by bringing a base, such as potassium hydroxide (KOH), into the slurry. Further, suitable temperature of the slurry is about from 20° C. to 50° C. when it is applied by a CMP method.

Furthermore, in the present slurry, because weak acid can repress erosion of metal, especial copper, which induced by nitric acid, application of weak acid not only can be used to adjust etching rate by affect interaction between metal (copper) and nitric acid, it also can be used to prevent metal (copper) from erosion.

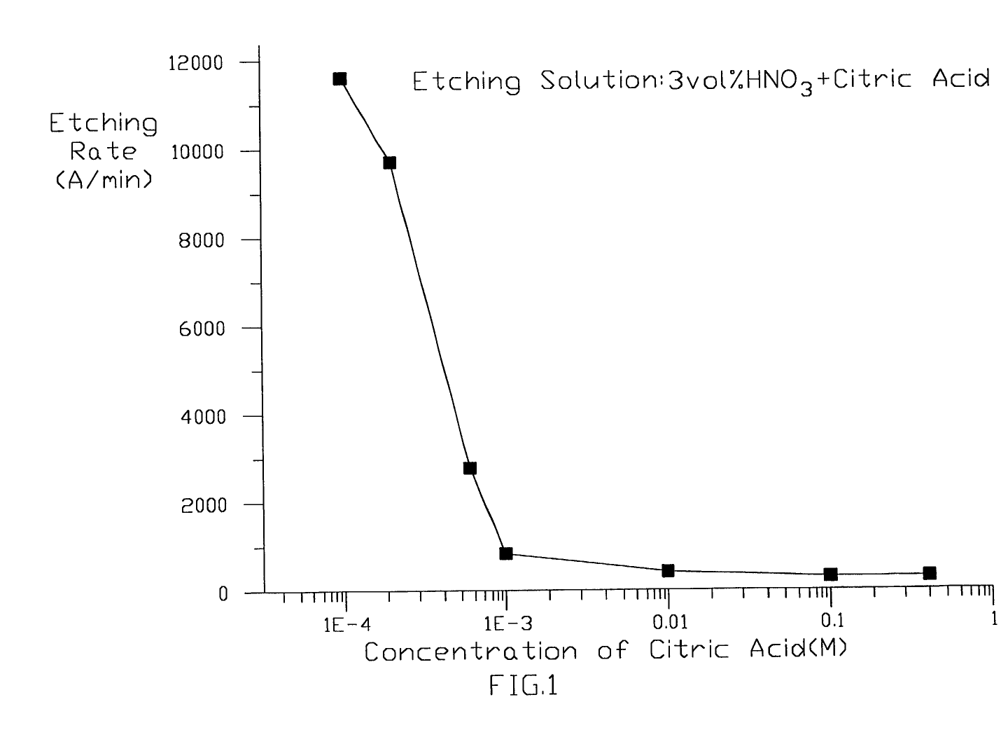

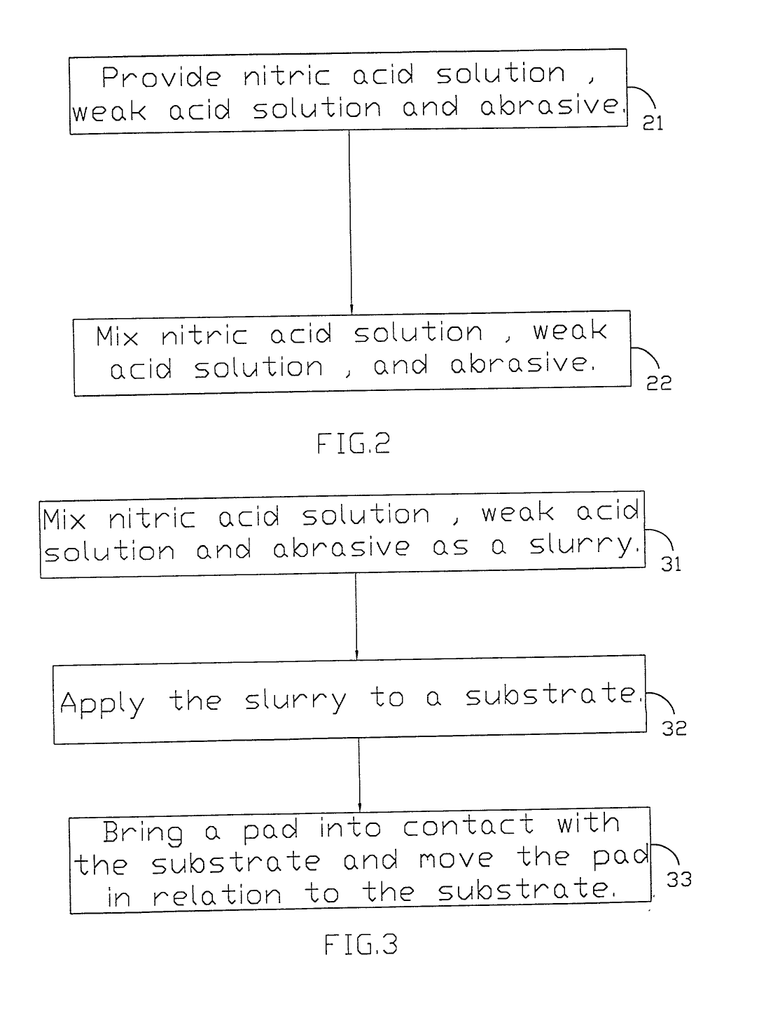

One practical example of the present chemical mechanical polishing slurry is application of citric acid. Referring to FIG. 1 where the relation between etching rate and mollar concentration of citric acid is shown, it is obviously that etching rate is dramatic varied from about 12000 angstroms/minute to about 1000 angstroms/minute when mollar concentration of citric acid is increased from about 0.0001 to about 0.5. Thus, the present slurry provide an effective way to precisely adjust etching rate of CMP method, which is unavailable for conventional slurry. Moreover, it should be emphasized that though mollar concentration of citric acid is varied form about 0.0001 to about 0.5, owing to quantity of citric acid is significantly less that quantity of nitric acid, pH value of the slurry is not obviously changed by variation of mollar concentration of citric acid.

Advantages of the present slurry further comprise that etching rate of barrier layer, such as Ti Layer and TiN layer, induced by the present slurry is very small, especially when compare to etching rate of metal layer, especially copper layer, induced by the present slurry. Therefore, application of the present slurry almost will not induce lose of barrier layer and dielectric layer, such as inter-layer dielectric layer. Whereby, an obvious characteristic and reason is that most of conventional slurries must be used within hydrogen peroxide and then barrier layer (and dielectric layer) will be removed, but application of the present slurry does not require hydrogen peroxide and then removal of barrier layer/dielectric layer will be dramatically decreased.

Another embodiment is a method for forming a chemical mechanical polishing slurry. The method comprises following steps: as providing block 21 shows, provide a nitric acid solution, a weak acid solution and an abrasive, wherein mollar concentration of the weak acid solution is less than mollar concentration of the nitric solution; and as mixing block 22 shows, mix the nitric acid solution, the weak acid solution and the abrasive. Herein, it should be noted that mixing order between the nitric acid solution, the weak acid solution and the abrasive is exchangeable. Further, pH value of the slurry usually is less than about 1.0.

The other embodiment is a method for polishing a substrate including at least one metal layer, such as copper layer. The method comprises following steps: mix a nitric acid solution, a weak acid solution, an abrasive and a solvent to form a chemical mechanical polishing slurry; apply the chemical mechanical polishing slurry to the substrate; and bring a pad into contact with the substrate and move the pad in relation to the substrate to remove a portion of the metal layer.

For most of practical configuration of substrate, these usually a barrier layer between the metal layer and an underlying dielectric layer, but the barrier layer is not totally removed when the metal layer is totally removed by application of the slurry. Herein, the barrier layer is selected from a group of titanium layer and titanium nitride layer, and the slurry usually is applied without application of a hydrogen peroxide. Further, etching rate of the metal layer usually is linearly dependent on concentration of the weak acid.

Although the present invention has been described and illustrated in detail, it is to be clearly understood that the same is by way of illustration and example only and is not to be taken by way of limitation, the spirit and scope of the present invention being limited only by the terms of the appended claims.

What is claimed is:

1. A chemical mechanical polishing slurry, comprising:
a nitric acid solution;
a weak acid solution, wherein mollar concentration of said weak acid acqeous solution is less than mollar concentration of said nitric acid acqeous solution; and
an abrasive.

2. The slurry of claim 1, wherein volume percent of said nitric acid is less than about 10.0%.

3. The slurry of claim 1, wherein volume percent of said nitric acid is about from 2.0% to 5.0%.

4. The slurry of claim 1, wherein mollar concentration of said weak acid solution is from about 0.0005 M to about 0.5 M.

5. The slurry of claim 1, wherein said weak acid is selected from the group consisting of citric acid, phosphoric acid, acetic acid, lactic acid, tartaric acid, succinic acid, oxalic acid and amino acid.

6. The slurry of claim 5, wherein mollar concentration of said citric acid is from about 0.0005 M to about 0.5 M.

7. The slurry of claim 5, wherein mollar concentration of said acetic acid is about from 0.001 M to about 0.5 M.

8. The slurry of claim 5, wherein mollar concentration of said phosphoric acid is about from 0.001 M to about 0.1 M.

9. The slurry of claim 1, wherein weight percent of said abrasive is less about 10.0%.

10. The slurry of claim 1, wherein said abrasive comprises a plurality of alumina particles.

11. The slurry of claim 10, wherein weight percent of said alumina particles is from about 2% to about 5%.

12. The slurry of claim 1, wherein pH value of said slurry is less than about 1.0.

13. The slurry of claim 1, wherein pH value of said slurry is essentially decided by concentration of said nitric acid.

14. The slurry of claim 1, wherein pH value of said slurry is adjusted by bringing a base into said slurry.

15. The slurry of claim 14, wherein said base is potassium hydroxide (KOH).

16. A chemical mechanical polishing slurry, comprising:
a nitric acid acqeous solution;
a weak acid acqeous solution; and
a plurality of micro-particles.

17. The slurry of claim 16, wherein said weak acid is selected from the group consisting of citric acid, phosphoric acid and acetic acid.

18. The slurry of claim 16, wherein pH value of said slurry is less than about 1.0.

19. A method for forming a chemical mechanical polishing slurry, comprising:
providing a nitric acid solution, a weak acid solution and an abrasive, wherein mollar concentration of said weak acid solution is less than mollar concentration of said nitric solution; and
mixing said nitric acid solution, said weak acid solution and said abrasive.

20. The method of claim 19, wherein mixing order between said nitric acid solution, said weak acid solution and said abrasive is exchangeable.

21. The method of claim 19, wherein pH value of said slurry is less than about 1.0.

22. A method for polishing a substrate including at least one metal layer, comprising:
mixing a nitric acid solution, a weak acid solution, an abrasive and a solvent to form a slurry;
applying said slurry to said substrate; and
bringing a pad into contact with said substrate and moving said pad in relation to said substrate to remove a portion of said metal layer.

23. The method of claim 22, wherein said metal layer comprises copper layer.

24. The method of claim 22, wherein said substrate further comprise a barrier layer that is located between said metal layer and an underlying dielectric layer of said substrate.

25. The method of claim 24, wherein said barrier layer is selected from a group of titanium layer and titanium nitride layer.

26. The method of claim 24, wherein a part of said barrier layer is not totally removed when a part of said metal layer is totally removed by application of said slurry, wherein said part of said barrier layer is located under said part of said metal layer.

27. The method of claim 22, wherein said slurry is applied without application of a hydrogen peroxide.

28. The method of claim 22, wherein etching rate of said metal layer is linearly dependent on concentration of said weak acid.
